(19) United States
(12) Patent Application Publication
(10) Pub. No.: US 2003/0039012 A1
(43) Pub. Date: Feb. 27, 2003

(54) Communication system and method to avoid laser-pulse broadening by multi-path effects

(76) Inventors: Joseph L. Pezzaniti, Harvest, AL (US); John S. Harchanko, New Market, AL (US); David B. Chenault, Hantsville, AL (US)

Correspondence Address: BIRCH STEWART KOLASCH & BIRCH, PO BOX 747, FALLS CHURCH, VA, 22040-0747, US

(21) Appl. No.: 09/933,002

(22) Filed: Aug. 21, 2001

(51) Int. Cl. H04B 10/00

(52) U.S. Cl. 359/156; 359/152

(57) ABSTRACT

A laser pulse communication system that orients a polarization analyzer to a state determined based on received laser pulses. The oriented state of the polarization analyzer allows a transceiver to obtain a replica of the transmitted laser pulses that are unbroadened by multiple reflections caused by inter-transceiver media. The obtained replica, therefore, has an enhanced signal to noise ratio.

### FIELD OF THE INVENTION

The present invention is directed to systems and methods for keeping or regaining the fidelity of data communicated by laser pulses transmitted in media causing multi-path reflections and atmospheric effects.

### BACKGROUND OF THE INVENTION

Optical communication has the advantage of large bandwidth as compared to lower communication frequencies. Optical communication, therefore, is becoming ever more important with the increase in the amount of data that is transmitted between parties.

Laser pulse transmission and reception is an important approach in optical data communication. Often, communicants have no control on the media between the transmitter and receiver. In free space communication, for example, the medium between the transmitter and receiver is the atmosphere. Additionally, there also exist multi-path reflections due to particulates and mist (when air is the transmission medium), as well as buildings and ground obstacles, that also broaden the transmitted laser pulses by multi-path effects. FIG. 1 schematically shows a multi-transceiver system 1000 wherein the transceivers communicate with each using laser pulses transmitted and received through a medium causing multi-path reflections. In FIG. 1, a transceiver 1200 transmits a laser pulse. After undergoing multi-path reflections in the inter-transceiver medium, the transmitted laser pulse is received by a transceiver 1100.

A laser beam has a finite beam cross-section. Various portions of a laser beam necessarily travel through different portions of the transmission media and, therefore, experience different characteristics of the transmission media. Consequently, various portions of the laser beam undergo different time delays. The receiver sees the overlap of these various portions of the laser beam and, therefore, receives a laser pulse that is effectively broadened. The broadening of the laser pulses, however, tends to wash out and, thus, deteriorate the information contained in the laser pulses. For example, as simplistically exemplified in FIG. 1, the broadening of a laser pulse due to multi-path reflections can causes the broadening and changing of a transmitted laser pulse representing 10101 (binary number corresponding to the value 21) into a received laser pulse of 111111 (binary number corresponding to the value 127).

Accordingly an approach is necessary for resolving the harmful effects of multi-path reflections—due to atmospheric non-uniformities and intervening obstacles—on laser pulse communication.

### SUMMARY OF THE INVENTION

The effects that lead to broadening of laser pulselengths due to multi-path reflections also change the polarization of the laser pulses. The present invention takes advantage of the change in polarization resulting from the multi-path effects, which broaden the length of a laser pulse, to obtain the unbroadened replicas of the laser pulse.

In principle, the apparatus and method implementing the inventive approach obtain replicas of the unbroadened laser pulses by filtering the laser pulses at a receiver according to reference polarization(s). In this manner, the receiver has access to the undeteriorated data contained in the laser pulse. A receiver according to the present invention includes at least one polarization analyzer to determine the replicas of the unbroadened laser pulses; the orientation of the polarization of the analyzer being either fixed or variable. Similarly, a method for practicing the invention includes analyzing the polarization of a received pulse to determine the replicas of the unbroadened laser pulses.

The inventive approach has the advantage of using relatively lightweight optical and electronic elements to obtain the unbroadened replicas of the laser pulses. Moreover, these elements are simple and readily available, have high dynamic range, and are highly predictable and repeatable in their operation. In a simple and inexpensive manner, therefore, the inventive approach can be used to improve the performance of laser communication systems.

As described below, an apparatus according to the present invention can be implemented as a stand-alone transceiver, or as a peripheral apparatus in other kinds of laser communication systems, that enhances the signal to noise ratio of detected laser pulses. The embodiments implementing the inventive concept can be used in methods and devices enabling unidirectional and bi-directional communication, including real-time two-way communication.

### BRIEF DESCRIPTION OF THE DRAWINGS

Other aspects and advantages of the present invention will become apparent upon reading the detailed description and accompanying drawings given hereinbelow, which are given by way of illustration only and which do not limit the present invention, wherein:

FIG. 1 is a schematic of laser pulse communication system wherein the laser pulses undergo multi-path reflections and are thus broadened;

FIG. 2A is a schematic of a communication system implementing the present invention and thus obtaining a replica of the unbroadened form of the transmitted laser pulses;

FIG. 2B is a schematic of a an embodiment of a transceiver according to the present invention;

FIG. 3A is a flow diagram of a method for using the embodiment of FIG. 2;

FIGS. 3B-3F are flow diagrams showing various implementations for step S302;

FIGS. 3G-3K are flow diagrams showing various implementations for step S303;

FIG. 4 is a flow diagram of another method for using the embodiment of FIG. 2A; and

FIG. 5 is a schematic of an embodiment of a peripheral apparatus according to the present invention.

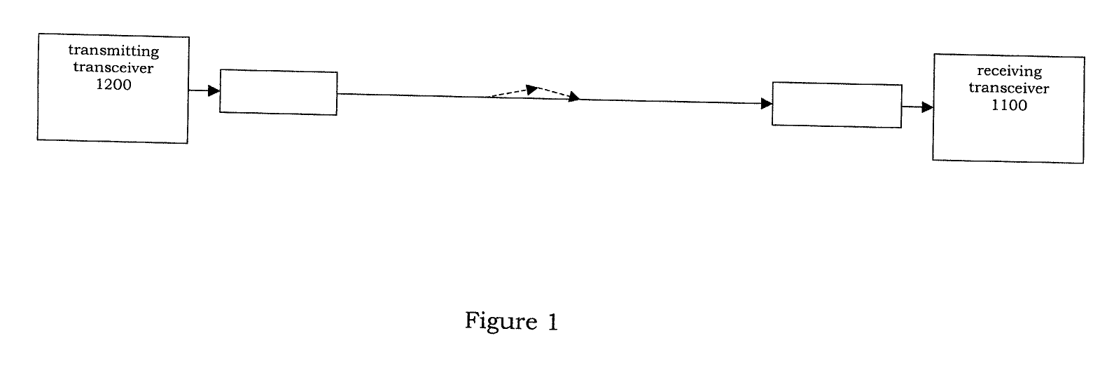

### DETAILED DESCRIPTION

In principle, the inventive approach is implemented by filtering the laser pulses at a receiver according to one or more reference polarizations to obtain replicas of the unbroadened laser pulses. In this manner, the receiver has access to the undeteriorated data contained in the laser pulse. The inventive approach places at least one polarization analyzer at a receiver to determine the replicas of the unbroadened laser pulses.

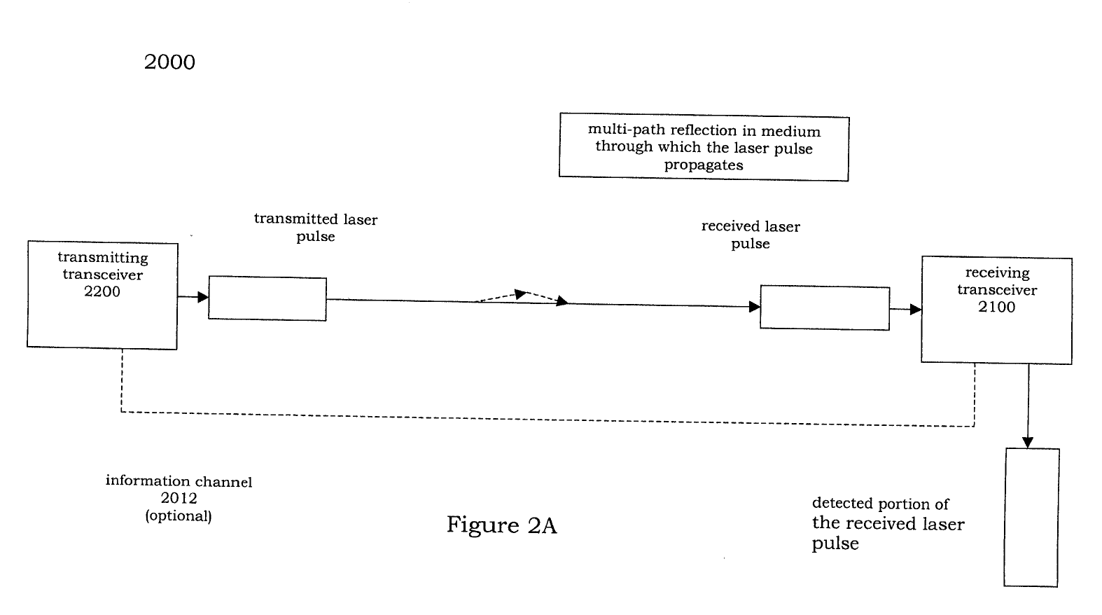

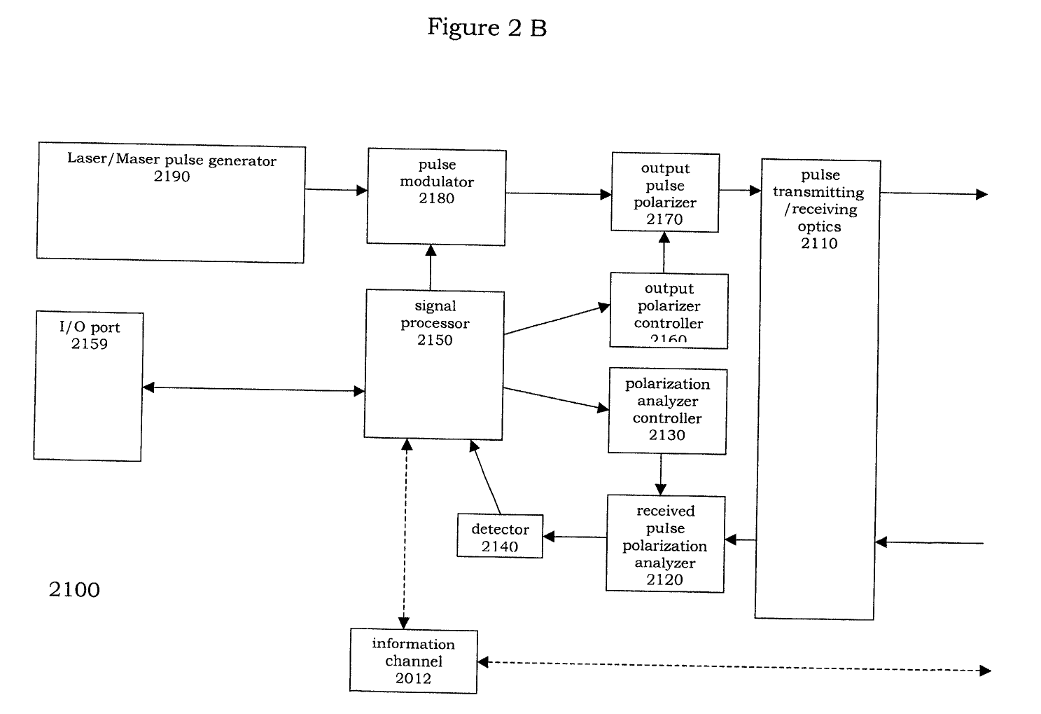

FIG. 2A shows a free space laser pulse communication system 2000 according to the present inventive concept. The communication system 2000 includes at least a transmitter 2200 and receiver 2100, connected by information channel 2012. The transmitter 2200 transmits a laser pulse having a specific polarization such as, but not limited to, linear, circular, or elliptical polarization. Information is impressed onto the laser pulse by amplitude modulation, for example. The environmental conditions between transmitter 2200 and receiver 2100 broaden the transmitted laser pulse and wash-out its modulation, thus deteriorating the information content of the pulse. According to the present invention, the receiver 2100 includes a polarization analyzer that analyzes the polarization of the received laser pulse; details of the receiver 2100, in transceiver form, being shown in FIG. 2B. When the orientation of the polarization analyzer matches the original polarization of the laser pulse, then the portion of the received pulse having this matched polarization is the narrowest and the least washed-out replica of the transmitted pulse. The communication system 2000 optionally includes information channel 2012, which connects transceivers 2100 and 2200. Channel 2012 may be used to communicate information between the transmitter 2200 and receiver 2100; the communicated information enabling the receiver 2100 to obtain information related to the polarization of the pulses transmitted by transmitter 2200. As explained below, the information channel 2012 can be implemented using the main information channel provided by the transmitted laser pulses or as a separate channel connecting the transmitter 220 and the receiver 2100. Information channel 2012 can also be represented by initially providing the receivers in the communication system 2000 with information about the polarization orientation of the transmitters.

FIG. 2B shows a preferred embodiment of a laser pulse transceiver 2100 according to the invention. As exemplified by FIG. 2, the transceiver 2100 includes laser pulse transmitting/receiving optics 2110, received pulse polarization analyzer 2120, polarization analyzer controller 2130, detector 2140, signal processor 2150, output polarizer controller 2160, output pulse polarizer 2170, laser pulse modulator 2180, and laser pulse generator 2190.

The laser pulse transmitting/receiving optics 2110 outputs the laser pulse being transmitted by transceiver 2100. It also acquires the laser pulse being transmitted to transceiver 2100. The laser pulse transmitting/receiving optics 2110 can be implemented using refractive optical components, or using reflective optical components or both. It can be implemented to include collimating or focusing optical components. The Laser pulse transmitting/receiving optics 2110 can be implemented as containing completely separate optical trains for the transmitting and receiving compartments of the transceiver 2100. Alternatively, it can be implemented using an optical train that is partially shared by the transmitting and receiving compartments of the transceiver 2100.

The received pulse polarization analyzer 2120 directs the portion of the received laser pulse having a specific desired polarization to the detector 2140. The polarization analyzer 2120 can be implemented as a component that highly transmits the portion of the laser pulse having a specific desired polarization to the detector 2140. Alternatively, the polarization analyzer 2120 can be implemented as a component that highly reflects the portion of the laser pulse having a specific desired polarization to the detector 2140. The polarization analyzer 2120 can be implemented using a single coating, or multi-coating, optics. Alternatively, the polarization analyzer 2120 can be implemented using wire or grating polarizer(s). Optionally, the polarizer(s) can be augmented with variable phase delay optics to control the polarization of the pulse that will be directed to the detector 2140 by varying the phase delay between laser pulse components having orthogonal polarizations. The phase delay optics can be implemented using material that is responsive to mechanical (in the form of, but not limited to, temperature, pressure, and stress), optical, electric, or magnetic effects.

The polarization analyzer controller 2130 controls the polarization analyzer 2120. The controller 2130 can be implemented using gears and at least one dial to adjust the polarization analyzer 2120. Alternatively, the controller 2130 can be implemented using at least one component that adjusts the polarization analyzer 2120 by responding to mechanical (in the form of, but not limited to, temperature, pressure, and stress), optical, electric, or magnetic effects.

The detector 2140 receives the component of the laser pulse being directed by the polarization analyzer 2120. The detector 2140 outputs a signal related to the laser pulse it receives. Preferably, this output signal includes a value representing the energy (or alternatively, the power) in the pulse the detector 2140 receives and, optionally, includes the information being communicated by the laser pulse. Preferably, the detector 2140 is exposed to an attenuated portion of the laser pulse directed by the polarization analyzer 2120 to avoid saturating the detector and the processing electronics when the transmitted signals have high power. Alternatively, the detector 2140 receives the unattenuated laser pulse directed by the polarization analyzer 2120 when the transmitted signals have are low power. In another preferred implementation a variable attenuator controllably varies the amount of received laser power being directed to the detector 2140.

Depending on the detected parameters, the detector 2140 preferably uses components having reaction speeds and dynamic ranges adequate to measure the pulse energy and to resolve the pulse profile in real time. The detector 2140 can be implemented using photodiode(s) containing semiconductor, superconductor, insulating, or metallic material(s). Alternatively, the detector 2140 can be implemented using phototransistor(s) or charge coupled device(s)—these examples being non-limiting.

The signal processor 2150 is operatively connected to the detector 2140 and processes the information it receives from the detector 2140. Based on the result of the processed information, the signal processor 2150 generates a control signal that is outputted to the controller 2130. This control signal indicates whether and how the orientation of the polarization analyzer 2120 is to be changed.

Preferably, the signal processor 2150 receives information through information channel 2012 about the orientation of the polarization of a laser pulse transmitted by the transmitting transceiver 2200. Based on this received information, the signal processor 2150 generates another control signal and outputs it to the controller 2130. This control signal indicates whether and how the orientation of the polarization analyzer 2120 is to be changed. Preferably, the signal processor 2150 transmits information through information channel 2012 to transceiver 2200. Preferably, signal processor 2150 also generates another control signal and outputs it to the output polarizer controller 2160. This control signal indicates whether and how the orientation of the output pulse polarizer 2170 is to be changed. However, the inventive concept can be implemented without signal processor 2150 generating and outputting the control signal to the polarizer controller 2160; an implementation wherein signal processor 2150 does not control the polarization orientation of the output pulse polarizer 2170.

In the preferred embodiment depicted in FIG. 2B, the signal processor 2150 is operatively connected to the information channel 2012, which connects transceivers 2100 and 2200. The information channel 2012 carries information that enables a transceiver to determine the polarization orientation of the transmitted laser pulses. Information channel 2012 can be used to communicate information originated at the receiving transceiver 2100 to transmitting transceiver 2200, or vise versa, or both. The carried information includes, individually or in various combinations, information related to a transceiver's identification, state of the polarization (and modulation of the polarization, if any, including an offset) of the pulse transmitted by the transmitting transceiver, timing synchronization, the length of overall transmitted pulse, the length of a single transmitted bit, or information characterizing the medium between the transceivers 2100 and 2200; this list not being limitative.

In a preferred embodiment, the information channel 2012 is implemented using the same physical link as that provided by the laser pulses being transmitted and received by the transceivers 2100 and 2200. In this implementation, the polarization information is impressed on laser pulses using a communication protocol that is different than the communication protocol used for communicating the general data impressed onto the laser pulses. The data about the polarization (optionally including other information) [hereinafter the “channel 2012 data”] does not change as often (if at all) as the general data being communicated. Consequently, the channel 2012 data can be put in header, or trailer, packages that are communicated at a rate that is much lower than the rate of communicating general data. Moreover, since the channel 2012 data is not as information intensive as the general data, communicating through information channel 2012 can be implemented using protocols that are more resistant to pulse broadening due depolarization. In another preferred embodiment, the information channel 2012 is implemented as a physically separate communication link such as, but not limited to, a fiber optical link, a microwave link, or a telephone line.

In the preferred embodiment depicted in FIG. 2B, the signal processor 2150 is also operatively connected to a user interfacing input/output port 2159. Through the input/output port 2159, users/operators convey messages to be transmitted by the transceiver 2100. Through the input/output port 2159, moreover, users/operators obtain messages that are received by the transceiver 2100.

The input/output port 2159 can be implemented using well known devices and components including, but not limited to, pointing device(s) (e.g., a mouse), keyboards, and display monitors. The signal processor 2150 can be implemented using microprocessors. Alternatively, the signal processor 2150 can be implemented using processors that are specialized including, but not limited to, Application Specific Integrated Circuits (ASIC) or Programmable Logic Arrays (PLAs).

The output polarization controller 2160 controls the output pulse polarizer 2170. The controller 2160 can be implemented using gears and dial(s) to adjust the output pulse polarizer 2170. Alternatively, the controller 2160 can be implemented using component(s) that adjust the output pulse polarizer 2170 by responding to mechanical (in the form of, but not limited to, temperature, pressure, and stress), optical, electric, or magnetic effects.

The output pulse polarizer 2170 polarizes the laser pulse output by the transceiver 2100. The output pulse polarizer 2170 can be implemented as a component that highly transmits the portion of the laser pulse having a specific desired polarization. Alternatively, the output polarizer 2170 can be implemented as a component that highly reflects the portion of the laser pulse having a specific desired polarization.

The output pulse polarizer 2170 can be implemented using a single coating or multi-coating optics. Alternatively, the output polarizer 2170 can be implemented using wire or grating polarizer(s). Optionally, the polarizer(s) can be augmented with variable phase delay optics to control the polarization of the output pulse; the phase delay optics being responsive to mechanical (in the form of, but not limited to, temperature, pressure, and stress), optical, electric, or magnetic effects.

In an exemplary implementation, the transmitted laser pulses have a fixed polarization state. In this implementation, a transmitter does not require complicated components to change the polarization of emitted laser pulses. In this implementation, moreover, a receiver requires less complicated components to keep track of laser pulses having the fixed state of polarization. This implementation has, therefore, the advantage of simplicity both for a transmitter and a receiver.

In another exemplary implementation, the transmitted laser pulses have a polarization state that is specifically modulated, information about which is provided to a receiving transceiver through, for example, information channel 2012. In this implementation, a transmitter requires more complex components to enable modulating the polarization of emitted laser pulses. In this implementation, moreover, a receiver requires more complex components to keep track of laser pulses having the modulated state of polarization; the more complex components including a lock-in-amplifier, for example. This implementation, therefore, has a cost of effectuating the specific modulation by a transmitter and a cost of processing for the specific modulation by a receiver. This implementation, however, has the advantage of enhancing the signal to noise ratio of data processed from received laser pulses.

Information to be communicated by the laser pulses are impressed onto the laser pulses by the laser pulse modulator 2180. For example, the modulator 2180 can be implemented as an amplitude modulator that modulates the temporal shape of the laser pulse. Such a modulator can be implemented using component(s) based on electro-optic, magneto-optic, or mechanical effects. The pulse modulator can be effectively controlled by the signal processor 2150 or, alternatively, by a different processor.

The modulator 2180 can be placed at various locations within the path of the laser pulses. FIG. 2B depicts the laser pulse modulator 2180 as being placed before the output polarizer 2170 as far as the propagation of the output laser pulse is concerned. Alternatively, the preferred embodiment depicted in FIG. 2B can be implemented by reversing the order of placing the laser pulse modulator 2180 and the output polarizer 2170.

The laser pulse generator 2190 generates the laser pulse being output by the transceiver 2100. The pulse generator 2190 can be implemented using a solid state laser, preferably including optical amplifiers to amplify the generated laser pulse. In other implementations, the pulse generator 2190 is implemented using other laser types including, but not limited to, semiconductor or molecular lasers, or masers. The pulse generator 2190 can be implemented to generate pulses having a wavelength within the millimeter to ultra-violet spectrum. In FIG. 2B, the pulse generator 2190 is separate from the components forming the pulse modulator 2180. However, in another implementation, the pulse generator includes the electronic and optical components necessary to impress the signal to be communicated onto the laser pulse.

Before describing another preferred embodiment implementing the inventive concept, various exemplary methods of using the embodiment of FIG. 2 will be described. In a preferred method of practicing the invention, the output polarizer 2170 of the transceiver 2100 is held at a fixed orientation. In another preferred method of operation, the output polarizer 2170 of the transceiver 2100 is modulated in a specific manner. Moreover, independent of how the output polarizer 2170 is operated, there are at least two exemplary modes of operating the polarization analyzer 2120: in a first exemplary mode of operation, the analyzer 2120 specifically follows the orientation of the polarization state of the output pulse polarizer 2170, of a transmitting transceiver 2200; in a second exemplary mode of operation, the polarization analyzer 2120 varies its state of polarization to optimize the signal to noise ratio of the received data.

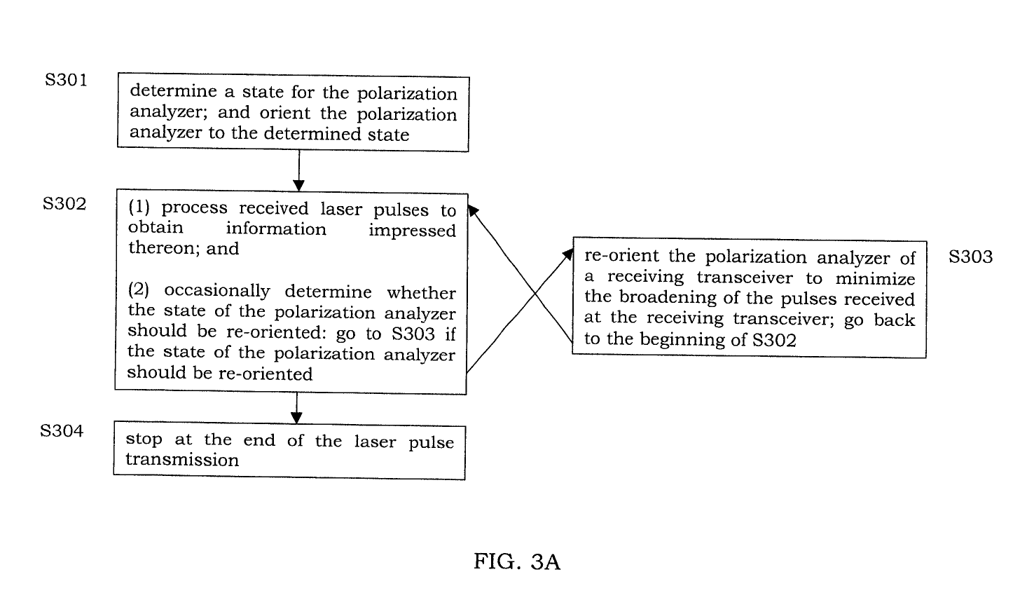

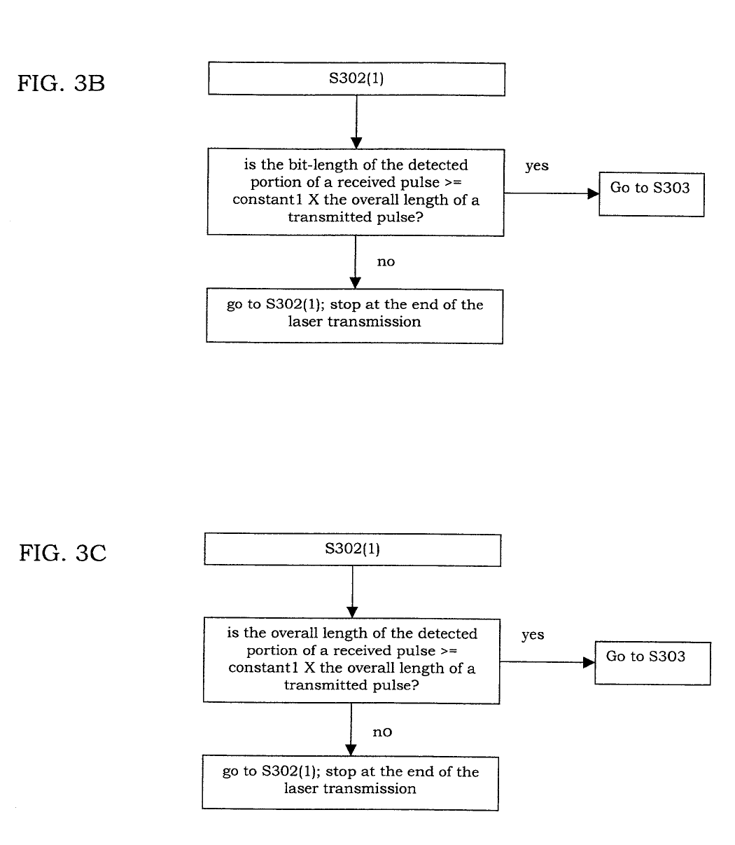

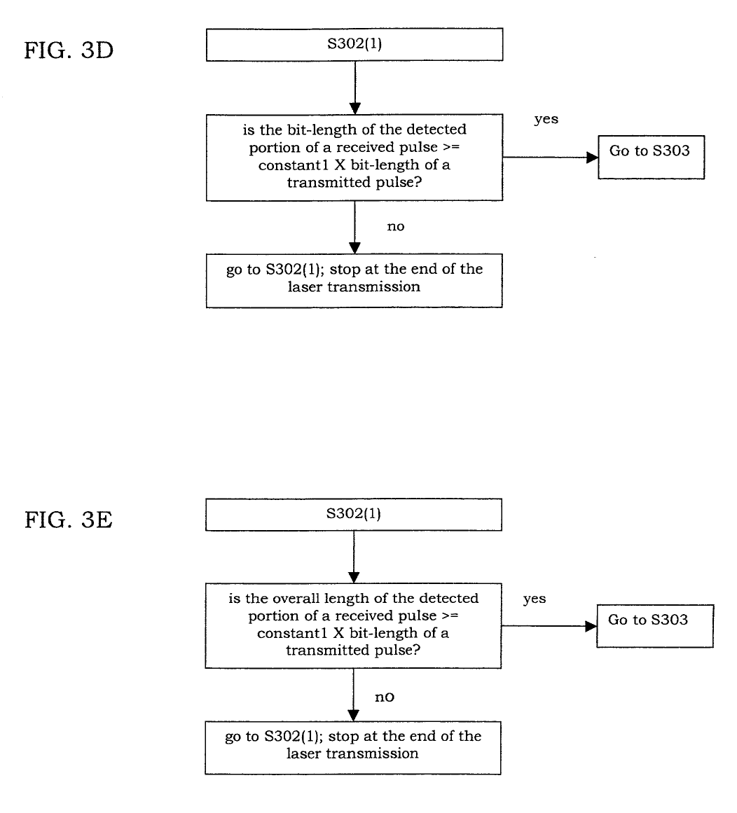

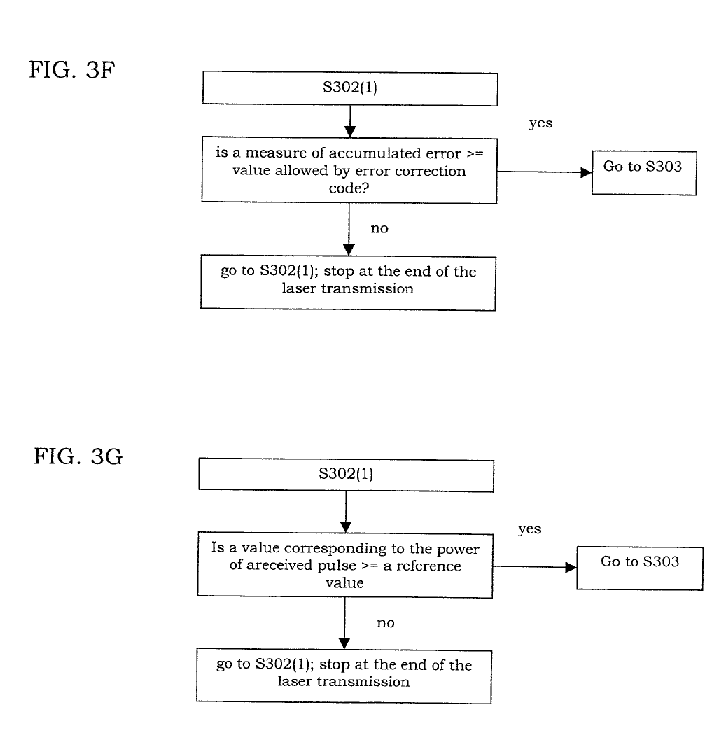

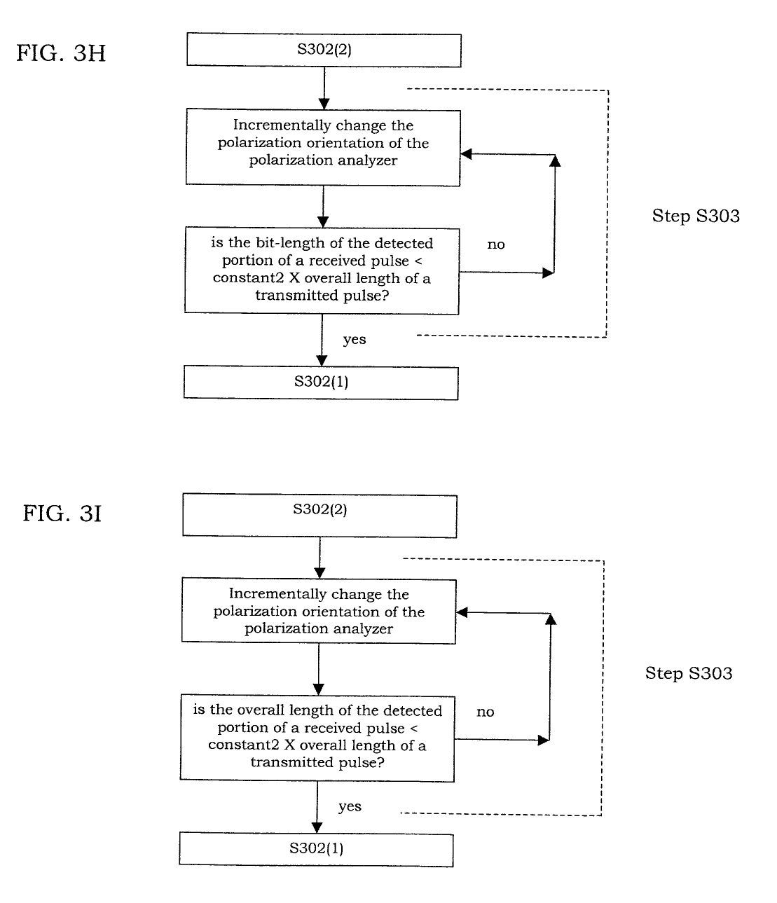

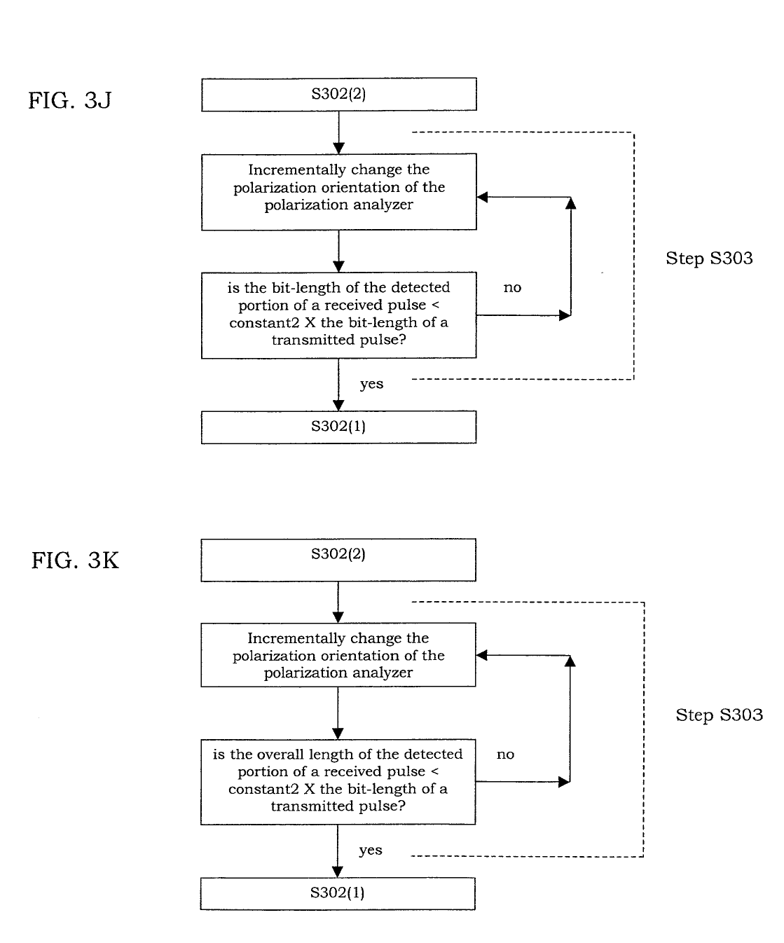

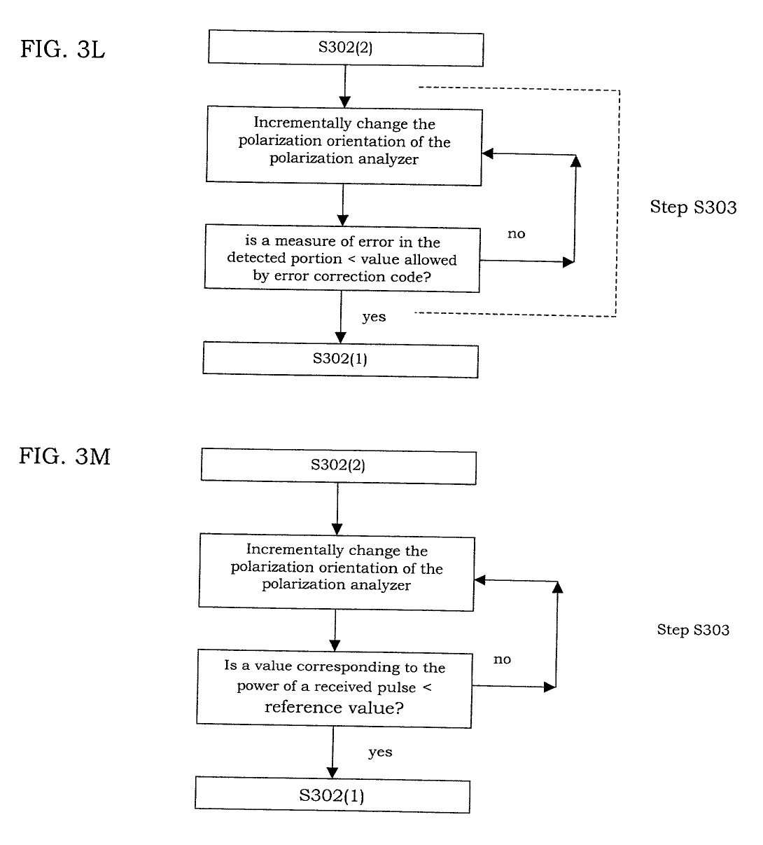

FIG. 3A shows a flow diagram describing a first preferred method of using the embodiment described in FIG. 2. In step S301, a transceiver 2100 determines a state for the polarization analyzer 2120 and orients it to the determined state. In an exemplary implementation for step S301, the signal processor 2150 determines the state of the polarization of the transmitted laser pulses (whether fixed or modulated) by, for example, processing data received through information channel 2012. The signal processor 2150 then generates and outputs a control signal, which includes the state of the polarization of the transmitted laser pulses as provided by information channel 2012. In response, the polarization analyzer controller 2130 orients the state of the polarization analyzer to correspond to that of the polarization of the transmitted laser pulses.

In various embodiments of the invention, the information channel 2012 does not provide information about the state of the polarization of the transmitted laser pulses. In such implementations, the signal processor 2150 preferably iteratively effectuates the changing in the state of the polarization analyzer 2120, while monitoring the resulting changes in the received laser pulses, until certain condition(s) is (are) met. A variety of conditions can be used to stop the iteration including, but not limited to, stopping the iteration when the length of the received laser pulses is judged to be absolutely minimized, or stopping when the length of the received laser pulses is judged to equal a reference value (either predetermined or dynamically determined) that allows appropriate resolution of the information impressed onto the laser pulses, or stopping based on a comparison of a value corresponding to the power of a received pulse with a reference value (either predetermined or dynamically determined), or stopping based on a combination of these conditions.

Iteratively varying the state of the polarization analyzer 2120 allows transceiver 2100 to obtain information about the inter-transceiver medium. The obtained information includes, but is not limited to, the depolarizing and/or the broadening characteristics of the medium. Transceiver 2100 can optionally provide this information to transceiver 2200 through, for example, information channel 2012 or through the laser pulse communication. Transceiver 2200 can then use this information to vary the polarization state of the transmitted pulses to further improve the signal to noise ratio of the received pulses. Transceiver 2100 can, moreover, optionally use this information to set the polarization state of the output pulse polarizer 2170 to control the polarization of the laser pulses transmitted by transceiver 2100.

In step S302, the laser pulses received at the receiving transceiver 2100 are processed to obtain information impressed onto the laser pulses. In one exemplary implementation, the signal processor 2150 processes the signals received from detector 2140 (or other detectors, not shown in FIG. 2). In another implementation, not shown in FIG. 2, a processor (or processors) other than processor 2150 processes the signals from the detector(s). Using processor(s) different than the signal processor 2150 can enhance the dynamic performance of the transceiver 2100 by, for example, allowing the parallel processing of information impressed onto the received pulses and the information necessary to control the polarization analyzer 2150.

In step S302, moreover, occasionally various conditions are tested to determine whether the state of the polarization analyzer should be re-oriented. Depending on results of the conditions tested, signal processor 2150 outputs a control signal to the polarization analyzer controller 2130. In response to this control signal, step S303 is performed, thus recovering a received laser pulse that is minimally broadened (i.e., optimally resolved). In one implementation, the condition(s) is (are) tested for every received pulse. In another implementation, testing is performed once every certain number of received pulses. In yet another implementation, testing is first performed for every received pulse and then it is performed once every few pulses as the inter-transceiver medium effects are better understood; this implementation including the later increase in the frequency of testing if inter-transceiver medium conditions change.

In step S302, various conditions can be used to determine whether to perform step S303. For example, as shown in FIG. 3B, in one preferred implementation the bit-length of the detected portion of a laser received pulse is compared with the product of the overall length of a transmitted laser pulse and a constant that is either predetermined or dynamically determined during communication. If the detected bit-length is determined to be larger than, or is equal to, the product, then Step S303 is performed, otherwise, step S302 is continued. Alternatively, as shown in FIG. 3C, the overall length of a detected portion of a received laser pulse is compared with the product of the overall length of a transmitted laser pulse and a constant that is either predetermined or dynamically determined during communication. Alternatively, as shown in FIG. 3D, the bit-length of the detected portion of a received laser pulse is compared with the product of the bit-length of a transmitted laser pulse and a constant that is either predetermined or dynamically determined during communication. Alternatively, as shown in FIG. 3E, the overall length of the detected portion of a received laser pulse is compared with the product of the bit-length of a transmitted laser pulse and a constant that is either predetermined or dynamically determined during communication. Alternatively, as shown in FIG. 3F, a calculated measure of the accumulated error in detected pulses is compared with a reference value, either predetermined or dynamically determined during communication, according to error correction codes. Alternatively, as shown in FIG. 3G, a value corresponding to the power of a received pulse is compared with a reference value, either predetermined or dynamically determined during communication.

Moreover, performing step S303 can be initiated at a reference frequency regardless of the conditions described above. Furthermore, performing step S303 can be initiated at the earlier of when a condition described above is met or when a set time has elapsed from the last performance of step S303.

In step S303, the state of the polarization analyzer 2120 of the receiving transceiver 2100 is re-oriented to minimize the broadening of the portion of laser pulses being directed to detector 2140. The minimization can be accomplished, for example, by the signal processor 2150 outputting a control signal to polarization analyzer controller 2140, the control signal including information about the state to which the polarization analyzer 2120 is to be re-oriented. The signal processor 2150 monitors the change in the characteristics of the received signal responsive to the change in the state of the polarization analyzer 2120. The signal processor preferably iterates the outputting of the control signal, while monitoring the change in characteristics of the detected signal, until an appropriate condition is realized. In one implementation, the iteration is repeated until a minimum broadening (i.e., a maximum resolution) is achieved. In another implementation, the iteration is repeated until the broadening is reduced to an appropriate reference amount (i.e., the resolution is appropriate). In another implementation, the iteration is repeated a specified number of times. In another implementation, plural previous implementations are used.

The criteria monitored in step S303 to determine whether an appropriate minimum broadening is achieved include, but are not limited to, relative measures of pulse lengths at the transmitting and receiving transceivers. For example, as shown in FIG. 3H, in one preferred implementation the bit-length of the detected portion of a received laser pulse is compared with the product of the overall length of a transmitted laser pulse and a constant that is either predetermined or dynamically determined during communication. If the detected bit-length is determined to be less than the product, then Step S302(1) is performed next, otherwise, step S303 is repeated. Alternatively, as shown in FIG. 31, the overall length of the detected portion of a received laser pulse is compared with the product of the overall length of a transmitted laser pulse and a constant that is either predetermined or dynamically determined during communication. Alternatively, as shown in FIG. 3J, the bit-length of the detected portion of a received laser pulse is compared with the product of the bit-length of a transmitted laser pulse and a constant that is either predetermined or dynamically determined during communication. Alternatively, as shown in FIG. 3K, the overall length of the detected portion of a received laser pulse is compared with the product of the bit-length of a transmitted laser pulse and a constant that is either predetermined or dynamically determined during communication. Alternatively, as shown in FIG. 3L, a calculated measure of the error in the detected portion of a received laser pulse is compared with a reference value, either predetermined or dynamically determined during communication, based on error correction codes. Alternatively, as shown in FIG. 3M, a value corresponding to the power of a received pulse is compared with a reference value, either predetermined or dynamically determined during communication.

The varying of the state of orientation of polarization analyzer 2120 allows transceiver 2100 to obtain information about the characteristics of the medium between the transceivers 2100 and 2200. The obtained information includes, but is not limited to, the depolarizing and/or the broadening characteristics of the medium. Transceiver 2100 can provide the obtained information to users of the communication system. For example, transceiver 2100 can provide this information to transceiver 2200 through, for example, information channel 2012. Transceiver 2200 can then use this information to vary the state of the polarization of the transmitted pulses and thus further improve the signal to noise ratio of the detected pulses. As another example, transceiver 2100 can optionally use this information to set the state of the polarization of the output pulse polarizer, thus setting the polarization of the pulses transmitted by transceiver 2100.

In between repeats of step S303, the state of the polarization for the polarization analyzer 2120 in the receiving transceiver 2100 follows the output state of the polarization in the transmitting transceiver 2200. Therefore, if the transceiver 2200 outputs a pulse having a fixed polarization, then the polarization analyzer 2120 has a state that is also fixed. On the other hand if the transceiver 2200 outputs a pulse that has a modulated polarization, then the polarization analyzer 2120 has a state that is similarly modulated. In step S305, after the end of the transmission of the laser pulses, transceiver 2100 performs the necessary housekeeping functions including, but not limited to, starting shutdown procedures, going into standby mode, or acting as a transmitting transceiver and sending a reply to transceiver 2200.

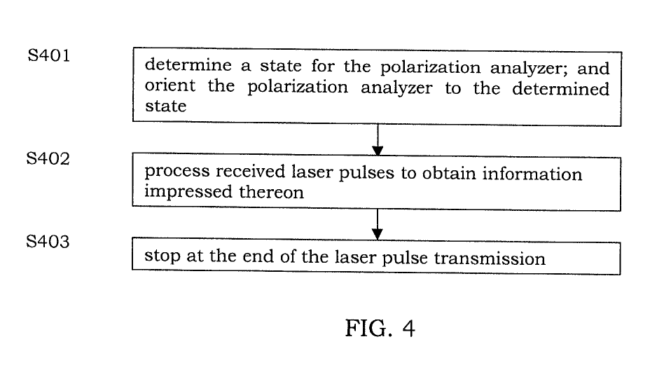

FIG. 4 shows a flow diagram describing another preferred method of using the embodiment described in FIG. 2. This method differs from the method described with respect to FIG. 3A by the absence of the substep of S302 wherein transceiver 2100 determines whether the polarization analyzer is to be re-oriented and step S303 wherein the state of the polarization analyzer is re-oriented. In the method described with respect to FIG. 4, the state of the polarization analyzer 2120 is not changed after it is determined.

In step S401, a transceiver 2100 determines a state for the polarization analyzer 2120 and orients it to the determined state. In a preferred implementation for step S401, the signal processor 2150 determines the state of the polarization of the transmitted laser pulses by, for example, processing data received through information channel 2012. In a preferred embodiment of practicing the inventive concept, the transmitted laser pulses have a fixed polarization state. Since the receiving transceiver 2100 does not have to change the state of the polarization analyzer 2120 once it is determined and effectuated, this implementation has the advantage of simplicity both for the transmitting transceiver 2200 and the receiving transceiver 2100.

In another preferred implementation for practicing the inventive concept, the transmitted laser pulses have a specifically modulated polarization, information about which is provided to transceiver 2100 through, for example, information channel 2012. In this implementation, in an exemplary step S401, the signal processor 2150 preferably processes the information about the specific modulation and appropriately effectuates the orienting of the state of the polarization analyzer 2120. Although this implementation has a cost of processing and effectuating the specific modulation, it nevertheless has the an advantage of enhancing the signal to noise ratio of data processed from detected portions of received laser pulses; the enhancement coming from using a lock-in-amplifier, for example.

In embodiments wherein the information channel 2012 does not provide information about the state of the polarization of the transmitted laser pulses, the receiving transceiver preferably obtains the necessary information through different means. In this case, an exemplary implementation of Step S401 is for the signal processor 2150 to iteratively effectuate the change in the state of the polarization analyzer 2120 until certain condition(s) is (are) met. A variety of conditions can be used to stop the iteration including, but not limited to, stopping when the length of a portion of a laser pulse detected by detector 2140 is judged to be absolutely minimized, or stopping when the length of the detected portion of a received laser pulse, detected by detector 2140, is judged to equal, or be less than, a reference value (either predetermined or dynamically determined) that allows appropriate resolution of the modulation impressed onto the laser pulses, or a combination of both.

The varying of the state of orientation of polarization analyzer 2120 allows transceiver 2100 to obtain information about the characteristics of the medium between the transceivers 2100 and 2200. The obtained information includes, but is not limited to, the depolarizing and/or the broadening characteristics of the medium. Transceiver 2100 can provide the obtained information to users of the communication system. For example, transceiver 2100 can provide this information to transceiver 2200 through, for example, information channel 2012. Transceiver 2200 can then use this information to vary the state of the polarization of the transmitted pulses and thus further improve the signal to noise ratio of the detected information. As another example, transceiver 2100 can optionally use this information to set the state of the polarization of the output pulse polarizer, thus setting the polarization of the pulse pulses transceiver 2100 transmits.

In a receiving transceiver 2100 being used according to the method described by FIG. 4, the state of the orientation of the polarization analyzer 2120 follows the state of the polarization of a pulse output by the transmitting transceiver 2200. Therefore, if the transceiver 2200 outputs a pulse having a fixed polarization, then the polarization analyzer 2120 has a state that is also fixed. This can be accomplished, for example, by the first control pulse including information about the state and offset of the orientation of the polarization of the pulses output by transmitting transceiver 2200. On the other hand if the transceiver 2200 outputs a pulse that has a modulated polarization, then the polarization analyzer 2120 has a state that is similarly modulated. This can be accomplished, for example, by the first control pulse including information about the state, offset, and modulation of the orientation of the polarization of the pulses output by transmitting transceiver 2200.

In step S402, transceiver 2100 processes the detected portion of received laser pulses to obtain the information impressed thereon. In one exemplary implementation, the signal processor 2150 processes the signals received from detector 2140 (or other detectors, not shown in FIGS. 2 and 4). In another implementation, not shown in FIGS. 2 and 4, processor (or processors) other than processor 2150 process the signals from the detector(s). Using processor(s) different than the signal processor 2150 allows the parallel processing of information impressed onto the received pulses and the information necessary to control the polarization analyzer 2150. In step S403, after the end of the transmission of the laser pulses, transceiver 2100 performs the necessary housekeeping functions including, but not limited to, starting shutdown procedures, going into standby mode, or acting as a transmitting transceiver and sending a reply to transceiver 2200.

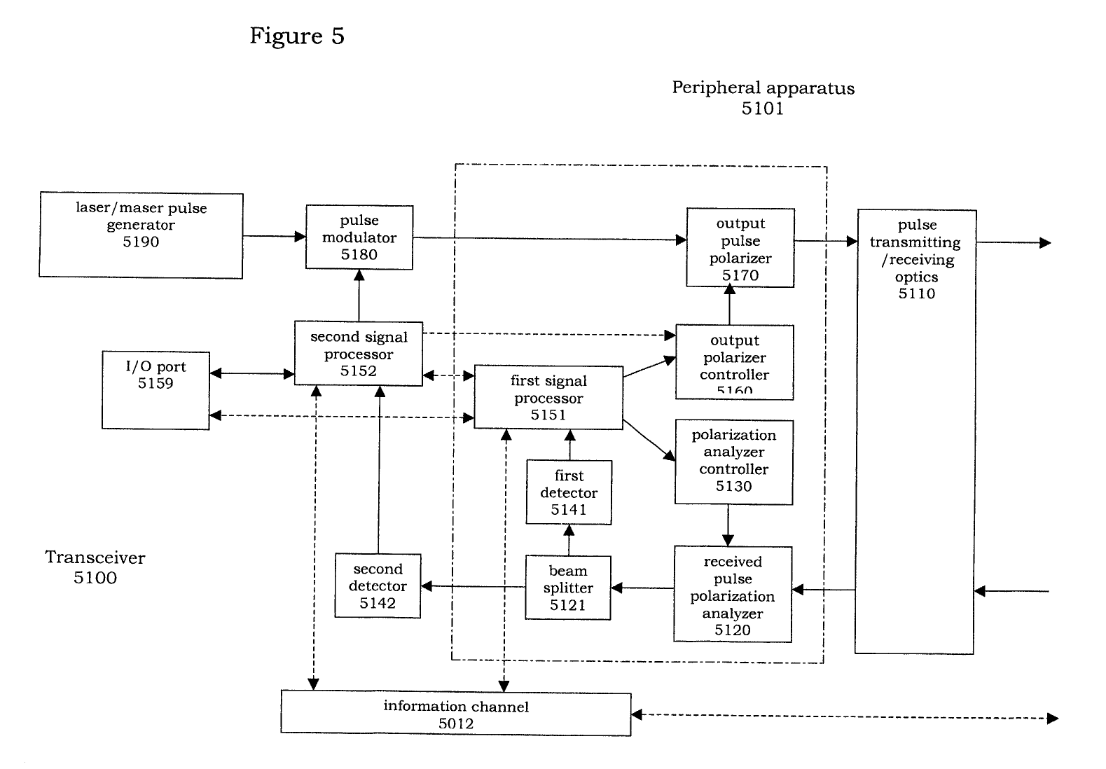

FIG. 5 shows a preferred embodiment of a peripheral apparatus 5101, according to the present inventive concept, forming part of a laser pulse transceiver 5100. The transceiver 5100 forms part of a free space laser communication system 2000 (with transceiver 5100 replacing transceiver 2100). Transceiver 5100 is optionally connected to an information channel 5012, which connects transceivers forming the communication system.

As exemplified by FIG. 5, the peripheral apparatus 5101, implementing the preferred embodiment of the present invention, includes received pulse polarization analyzer 5120, beam splitter 5121, polarization analyzer controller 5130, first detector 5141, first signal processor 5151, output polarizer controller 5160, and output pulse polarizer 5170. The peripheral apparatus 5101 is integrated with the laser pulse generating and modulating component 5102 to form the transceiver 5100. The laser pulse generating and modulating component 5102 includes laser pulse transmitting/receiving optics 5110, second detector 5142, second signal processor 5152, input/output port 5159, laser pulse modulator 5180, and laser pulse generator 5190. The received pulse polarization analyzer 5120, the polarization analyzer controller 5130, the output polarizer controller 5160, the output pulse polarizer 5170, the input/output port 5159, the laser pulse transmitting/receiving optics 5110, the laser pulse modulator 5180, the laser pulse generator 5190, and the information channel 5012 are similar to the received pulse polarization analyzer 2120, the polarization analyzer controller 2130, the detector 2140, the output polarizer controller 2160, the output pulse polarizer 2170, the laser pulse transmitting/receiving optics 2110, the laser pulse modulator 2180, the laser pulse generator 2190, and the information channel 2012, respectively.

The beam splitter 5121 is in the path of the laser pulse as it is directed by the polarization analyzer 5120. A small portion of the received laser pulse is split off by the beam splitter 5121 and is directed towards the first detector 5141. In one preferred implementation, the beam splitter 5121 is based on multicoated transmitting optics. In another preferred implementation, the beam splitter 5121 is a highly reflective surface partially intruding into the path of the laser pulse. Preferably, the major portion of the received laser pulse being directed by the polarization analyzer 5120 continues towards the second detector 5142.

Based on the small portion of the received laser pulse, the first detector 5141 outputs a signal to the first signal processor 5151. The first processor 5151 processes this signal and outputs signal(s) to the analyzer controller 5130 and polarizer controller 5160. The controllers 5150 and 5160 in turn control the orientation and reorientation of the received polarization analyzer 5120 and the output polarizer operation, respectively.

Based on the major portion of the received laser pulse, which is not split off by the beam splitter 5121 and directed by it towards the detector 5141, the second detector 5142 outputs a signal to the second signal processor 5152. The second processor 5152 processes this signal to obtain the information received through the laser pulses and outputs signal(s) indicating the received information to the input/output port 5159. The second processor 5152 also processes information (received from the input/output port 5159) to be transmitted by the laser pulses and outputs signal(s) based on the processed information to the laser pulse modulator 5180.

Preferably, the first signal processor 5151 or the second signal processor 5152, or both, are operatively connected to the information channel 5012. In one preferred implementation, the signal processors 5151 and 5152 are operatively connected to each other and exchange information. In another preferred implementation, the signal processors 5151 and 5152 are not operatively connected to each other. In the non-connected implementation, the first signal processor 5151 is optionally connected to its own input/output port and thus allows users to have access to the information generated by the first signal processor 5151. The first signal processor 5151, the second signal processor 5152, the first detector 5141, and the second detector 5142 can be implemented in the variety of ways that signal processor 2150 and detector 2140 are implemented.

FIG. 5 shows one of the value-enhancing features of the inventive concept. The peripheral apparatus 5101, which exemplifies a preferred embodiment according to the inventive concept, can be used to modify or adapt laser communicating systems in a simple manner to avoid the deleterious effects of signal broadening caused by the inter-transceiver media. Currently, due to mass producing of electronic and optical components, various components making the peripheral apparatus 5101 are readily available and inexpensive. The peripheral apparatus 5101, therefore, allows improving the performance of other laser pulse communication systems in a direct manner that is also simple and inexpensive. Moreover, the embodiment of the present invention schematically shown in FIG. 5 can be modified so that output polarizer controller 5160 and output pulse polarizer 5170 are not part of the peripheral apparatus 5101.

The transceiver 5100, including the peripheral component 5101 and the pulse generating-modulating component 5102, can be used in the various ways described above with respect to the transceiver 2100.

In a laser pulse communication system implementing the inventive concept, the transceiver 2200 can be implemented as either a transceiver 2100 or a transceiver 5100.

The inventive concept can be used in free space (including air) laser communication systems. It can also be used in under water laser communication systems. It can also be used in communicating between transceivers separated by water and free space. The inventive concept can be also be used in systems wherein the inter-transceiver medium is other than water or free space including fibers.

The conditions of the media through which the laser pulses are transmitted may impose a phase shift on the polarization of the received laser pulses with respect to the polarization of the transmitted laser pulses. For example, due to the Faraday Effect, the presence of magnetic fields causes certain materials to rotate the polarization of electromagnetic radiation transmitted therethrough. Therefore, a modification of the exemplary implementations of steps S301 and S401 is for the transceiver 2100 (5100) to determine whether the state of the polarization analyzer 2120 (5120) should be phase shifted with respect to the state of the polarization of the transmitted laser pulses. In a preferred implementation, the transceiver 2100 (5100) accomplishes this determination by processing information about the conditions of the inter-transceiver medium. In an exemplary implementation, the transceiver 2100 (5100) obtains this information from the transmitting transceiver 2200 (5200) through information channel 2012 (5012). In another exemplary implementation, the information is provided to the transceiver 2100 (5100) through input/output port 2159 (5159). Alternatively, in another exemplary implementation, wherein the transceiver 2100 (5100) does not receive information about the phase-shift through, the transceiver 2100 (5100) determines the phase shift as part of step S301 (step S401) by iteratively varying the state of the polarization analyzer 2120 (5120). In this implementation, the determined phase-shift is optionally provided to users of the communication system through, for example, input output port 2159 (5159) or information channel 2012 (5012).

The inventive concept can be implemented in embodiments using fibers to direct the laser pulses between the various components of the transceivers 2100 and 5100.

The inventive concept can be implemented in embodiments where providing the transceiver identifying information, as part of the handshake protocol, enables the signal processors 2150 and 5151, or their equivalents, to determine the polarization of the transmitted laser pulses, for example, by using a table of identifications and polarizations.

As described above, the inventive concept can be used as a stand-alone transceiver or as a peripheral apparatus that enhances the signal to noise ratio of received signals in other kinds of laser communication systems. The inventive concept can be implemented, using simple and easily available optical and electronic components, as a stand-alone transceiver or as a peripheral apparatus in other kinds of laser communication systems to enhance the signal to noise ratio of received signals. The embodiments implementing the inventive concept can be used in one way and enable two-way communication in real-time.

Although the present invention has been described in considerable detail with reference to certain exemplary embodiments, it should be apparent that various modifications and applications of the present invention may be realized without departing from the scope and spirit of the invention. Scope of the invention is meant to be limited only by the claims. All such variations and modifications as would be obvious to one skilled in the art are intended to be included within the scope of the claims presented herein.

We claim:

1. A terminal for use in a communication system including plural terminals separated by a fluid inter-terminal medium, said terminal for receiving laser pulses, which are polarized when transmitted and which have information impressed thereon, said terminal comprising:
a polarization analyzer having a polarization orientation;
a detector operatively connected to said polarization analyzer, said detector detecting portions of the received laser pulses; and
a processor operatively connected to said detector and said polarization analyzer, said processor operatively arranged to determine a polarization state for said polarization analyzer and operatively arranged to change the polarization orientation of said polarization analyzer to said determined polarization state, said processor thereby reducing the broadening of the detected portions of the received laser pulses.

2. The terminal according to claim 1, wherein said processor is operatively arranged to effectuate the varying of said determined polarization state to optimize reducing the broadening of the detected portions of the received laser pulses.

3. The terminal according to claim 2, wherein said varying of said determined polarization proceeds based on comparing a reference value with a characteristic length of a detected portion of a received laser pulse.

4. The terminal according to claim 3, wherein said reference value is the length of a bit in a transmitted laser pulse or is the overall length of a transmitted laser pulse, wherein said characteristic length of a detected portion of a received laser pulse is the length of a bit of a detected portion or is the overall length of a detected portion, and wherein said varying of said determined polarization continues until said reference value is equal to, or is greater than, said characteristic length of a detected portion of a received laser pulse.

5. The terminal according to claim 2, wherein said varying of said determined polarization proceeds based on comparing accumulated detection error and a reference value.

6. The terminal according to claim 1, further comprising:
an input operatively connected to said processor, said input being connectable to an information channel, which channel provides information about the polarization of received laser pulses when transmitted.

7. The terminal according to claim 1, further comprising a laser pulse receiver receiving laser pulses.

8. The terminal according to claim 7, further comprising a laser pulse transmitter outputting a polarized laser pulse.

9. The terminal according to claim 8, wherein the polarization of said outputted laser pulse is linear, circular, or elliptical.

10. The terminal according to claim 9, wherein the polarization of said outputted laser pulse is modulated.

11. A method for using polarized laser pulses in a communication system including plural terminals separated by a fluid inter-terminal medium, said method comprising the steps:
receiving laser pulses, which are polarized when transmitted;
processing information to determine a state of polarization corresponding to the polarization of the received laser pulses when transmitted;
detecting selectively portions of received laser pulses, said portions having a polarization matching said determined state of polarization; and
obtaining a replica of the unbroadened transmitted laser pulses based on the result of said detecting selectively step.

12. The method according to claim 12, wherein said step of detecting selectively includes setting the polarization orientation of a polarization analyzer based on said step of processing information.

13. The method according to claim 12, wherein said step of setting the polarization orientation of a polarization analyzer proceeds based on comparing a reference value with a characteristic length of a detected portion of a received laser pulse

14. The method according to claim 13, wherein said reference value is the length of a bit in a transmitted laser pulse or is the overall length of a transmitted laser pulse, wherein said characteristic length of a detected portion of a received laser pulse is the length of a bit of a detected portion or is the overall length of a detected portion, and wherein said varying of said determined polarization continues until said reference value is equal to, or is greater than, said characteristic length of a detected portion of a received laser pulse.

15. The method according to claim 12, wherein said step of setting the polarization orientation of a polarization analyzer includes obtaining a measure of accumulated error, said step of setting the polarization orientation proceeding based on comparing a reference value and said measure of accumulated error.

16. The method according to claim 12, further comprising the step of optimizing said obtained replica of the unbroadened laser pulses by occasionally varying the polarization orientation of the polarization analyzer.

17. The method according to claim 12, wherein said processing information includes receiving information through a side channel.

18. The method according to claim 12, further comprising the step of transmitting a laser pulse.

19. The method according to claim 12, wherein the polarization of the laser pulse transmitted by said transmitting step is linear, circular, or elliptical.

20. The method according to claim 12, wherein the polarization of the laser pulse transmitted by said transmitting step is modulated.

21. The method according to claim 12, wherein said step of setting the polarization orientation of a polarization analyzer proceeds based on comparing a value corresponding to the power of a received pulse with a reference value.

22. The terminal according to claim 2, wherein said varying of said determined polarization proceeds based on comparing a value corresponding to the power of a received pulse with a reference value.
